(19) United States
(12) Patent Application Publication
(10) Pub. No.: US 2011/0119933 A1
(43) Pub. Date: May 26, 2011

(54) POWER TOOL, ESPECIALLY HAND-HELD POWER TOOL

(75) Inventors: Hans Kaiser, Leuzigen (CH); Thilo Koeder, Gerlingen (DE); Joachim Platzer, Remseck-Hochberg (DE); Ulli Hoffmann, Niefern-Oeschelbronn (DE); Jan Koegel, Mount Prospect, IL (US)

(73) Assignee: Robert Bosch GMBH, Stuttgart (DE)

(21) Appl. No.: 12/992,743

(22) PCT Filed: Mar. 16, 2009
(86) PCT No.: PCT/EP09/53038

§ 371 Date: Feb. 2, 2011

(30) Foreign Application Priority Data
May 14, 2008 (DE) 10 2008 001 772.8

(51) Int. Cl. B23D 49/16; B23D 51/02

(52) U.S. Cl. 30/376; 30/374

(57) ABSTRACT

The invention relates to a power tool (1), which is designed as a jigsaw (2) and which comprises a rear support (2) for the saw blade (8) at a right angle to the rotational axis (22) of the saw blade (8). Said driven support (20) allows adjustment of the saw blade (8) in different angular positions in the rotational direction around its rotational axis (22).

The invention relates to a power tool, especially a hand-held power tool according to the generic term of claim 1.

### STATE OF THE ART

Power tools of the previously mentioned type are known from EP 1 598 136 B1, namely in the configuration as jigsaws, at which the saw blade is driven in a manner allowing stroke movement and which works in normal operation at a drive exclusively in a manner allowing stroke movement. If the drive that can be moved in strokes can be overlapped by a rotational movement around a pivot axis that lies transversely to the saw blade plane, the jigsaw works in the pendulum stroke mode. In a further operating mode the jigsaw works as a so-called scrolling jigsaw. At the scrolling jigsaw a pivoting ability of the saw blade around a rotational axis that is running around its longitudinal direction is given in addition to the lifting drive of the saw blade, so that the corresponding working direction is basically predefined by rotating the saw blade.

The saw blade is impinged in all operating modes by a support with a support arrangement on the back side, which is basically defined concentrically rotating to the saw blade or the lifting rod of the saw blade and which provides a supporting roller as supporting element that is impinging the saw blade back. It is supported at an arm that is running in longitudinal direction of the rotational axis, which provides a low pivoting mobility in the direction of the saw blade plane.

Therefore the same alignment in the rotating position of the support arrangement towards the saw blade is practically given independent of the corresponding operating type. A variation of the support circumstances with regard to different working conditions is therefore hardly possible. Furthermore this results in a relatively elaborate construction.

### DISCLOSURE OF THE INVENTION

The invention is based on the task to achieve improved conditions for the creation of different supporting circumstances at least without further complicating the construction.

According to claim 1 the saw blade is driven over the support arrangement in rotational direction. Therefore an arrangement towards the lifting rod and if necessary also towards the lifting rod guiding on the side of the housing is possible, which is independent in the position of the rotational axis, without having to waive a common drive regarding the twistability and due to the twistability of the support arrangement and the saw blade to each other, but a forced coupling regarding the twistability around a common axis is avoided. Furthermore also the initiation of operational torques takes place over the support, so that favorable exposure circumstances result for the saw blade, also due to the decoupling of the forces that are initiated into the saw blade and affecting the saw blade regarding the stroke movement and the rotational movement.

The decoupling can be simply achieved within the scope of the invention with regard to the twistability by a case guide. Instead of that the saw blade holder can also be construed in such a way that the saw blade is held over it in a manner that is can be rotated around its axis.

According to the invention it is useful to provide a guide along a guiding surface that is partially encompassing towards the saw blade for the support arrangement, whose pole lies at least in the area of the rotational axis of the saw blade, whereby the guiding surface can be realized in its course also with different distances to the pole, in order to influence the supporting conditions by this means.

The guiding surface is usefully construed as link guide. For the support arrangement a support arm is advantageous in the connecting of the guiding surface to the saw blade back, which is supported against the saw blade back by a supporting element, which is especially also construed as supporting roller.

The supporting roller can be provided with a guiding channel at the circumferences, into which the saw blade sinks in on the back, so that a support between the supporting roller and the saw blade also results transversely to the saw blade plane.

Advantageous is furthermore, in particular also for reducing the wear between the supporting roller and the saw blade a configuration of the supporting roller with a concavely vaulted contour on the circumferences, usefully in such a way, that the circumferential vaulting provides a rounding radius, whose size corresponds with the distance of the rotational axis of the saw blade to the saw blade back, whereby also a stronger curve towards the rims of the vaulting can be useful.

For the support arm a configuration as support yoke proves to be advantageous, which is held in the guiding link in the area of its bridges by link blocks, whereby tappets, rollers or such alike can be used as link blocks, which can also be in particular construed as guiding bodies that are resilient and therefore compensating a backlash.

For the support arm also a rotatable support to the housing of the machine, in particular to the lifting rod guide on the side of the housing can be provided in addition to the guiding over the guiding link, which contributes to the position stabilization of the support arm, and therefore also to the creation of improved supporting conditions between the supporting element, the support arrangement and the saw blade. This proves to be useful in particular with the adjustment of the rotational position of the saw blade over the support arrangement. The rotational position of the drive arrangement takes advantageously place by an actuator, which attacks at the drive arrangement, in particular at the support arm or also at the drive arm, which incorporates the guiding link for the support arm.

With regard to a tilting-free support of the saw blade back to the saw blade in particular also a rounded configuration comes into question for the saw blade back within the scope of the invention, and this preferably at a support of the saw blade back by a supporting element, which provides a vaulted supporting contour that is not rotating along.

Further advantages and useful embodiments can be taken from the claims, the description of the figures and the drawings. It is shown in:

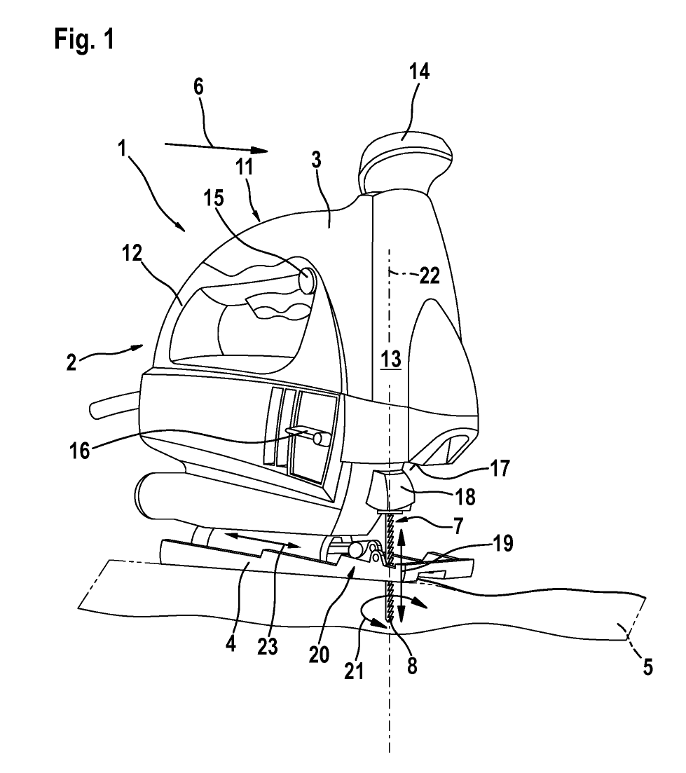

FIG. 1 a schematic illustration of an electrically driven jigsaw, which is construed as a hand-held power tool, and for which different operating modes are provided,

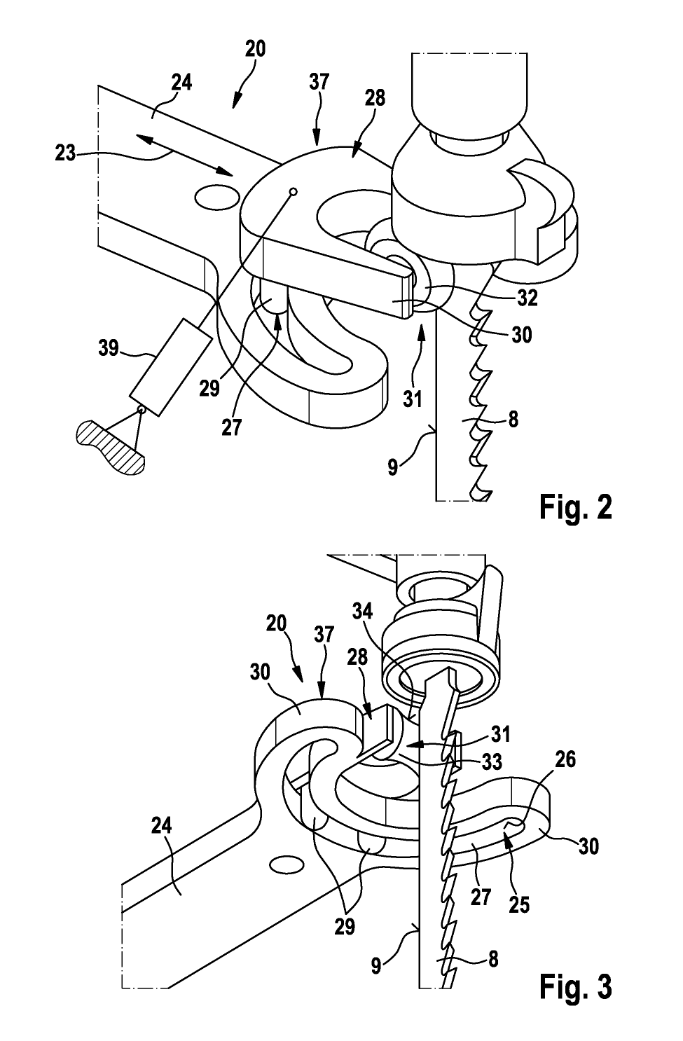

FIGS. 2 and 3 support arrangements for a saw blade of a jigsaw according to FIG. 1, whereby the support arrangement is dragged along at a rotation of the saw blade around its rotational axis,

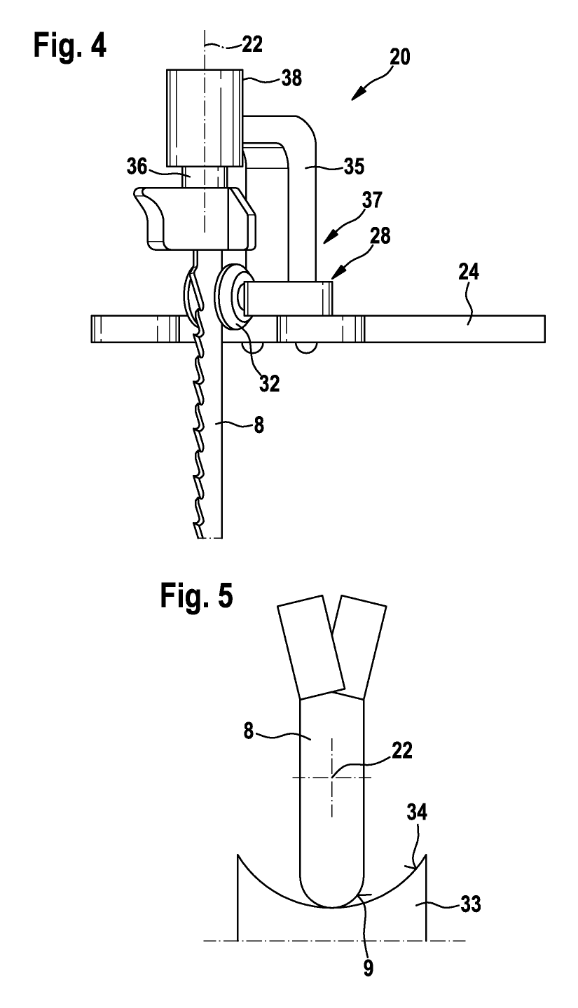

FIG. 4 an arrangement that corresponds with FIGS. 2 and 3 with a bridge-like support of the support arm of the support arrangement, and

FIG. 5 a further illustration of the assignment of the saw blade to a supporting element of the support arrangement.

FIG. 1 illustrates a hand-held machine as an example of a power tool in the form of a jigsaw 2, which provides a housing 3 and which is supported over a foot plate 4 on a work piece 5.

In the front area of the jigsaw 2 in the working direction it provides a saw blade 8 as working tool 7. It encroaches in the working cycle upon the work piece 5, on which the jigsaw 2 is supported movably over the foot plate 4.

A handle 11 is provided at the housing 3 of the jigsaw 2 in vertical direction opposing the fixedly supported foot plate 4 that is running around a pivot axis in the direction of the longitudinal axis of the jigsaw 2, whose handle bow 12 runs towards a guiding knob 14. Encompassing the handle bow 12 a switch arrangement 15 is provided, over which the jigsaw 2 can be switched on and off Different operating modes of the jigsaw 2 can be adjusted over the switch device 16 that is provided on the longitudinal side at the housing 3. The front wall area 13 of the housing 3 running towards the foot plate 4 is offset stepwise contrary to the working direction. The step 17 covers the power tool holder 18 for the driven work tool 7 that is established by the saw blade 8.

The saw blade 8 of the overall electrically driven power tool 1 provides a basic working position, in which it is only driven in a manner allowing stroke movement and which is oriented in the direction of the not shown longitudinal axis of the jigsaw 2, as it is illustrated by arrow 19.

The back 9 of the saw blade 8 is assigned to a support 20, which comprises a support arrangement 37. The support 20 is driven in a manner allowing stroke movement by a not shown drive in the direction of the plane of the saw blade 8 (arrow 23). This results in a further operating mode, namely the so-called pendulum stroke operation, in which the saw blade 8 can be pivoted around a not shown pivot axis that runs transversely to its blade plane and therefore also transversely to the sawing direction, overlapped to the stroke movement running in the longitudinal direction of the saw blade 8 (arrow 19). In a third operating mode, illustrated by arrow 21, the saw blade 8 can additionally be pivoted towards the stroke movement in the direction of its longitudinal axis around a rotational axis 22, which runs in its directions, and which is schematically indicated in FIG. 1. Thereby the saw blade 8 can be adjusted in angled working directions towards its straight working direction according to arrow 6 that corresponds with the basic working position, so that the jigsaw 2 can be used as so-called “scrolling jigsaw” and be also driven as semi-autonomous jigsaw 2 at a correspondingly controlled adjustment of the saw blade 8. Thereby the user who is holding the jigsaw 2 basically only takes over the feed that is roughly aligned towards the working direction, while an exact positioning that is oriented at a predefined course by adjusting the saw blade 8 on to a rotational position that corresponds with that predefined course.

FIGS. 2 and 3 illustrate the support 20 with its support arrangement 37. The support 20 comprises the drive arm 24, which is driven in pendulum stroke mode in the direction of the arrow 23 in a manner allowing stroke movement and which ends in a guiding surface 26 that corresponds with the drive arrangement 37 and that is construed as guide link 25. The guiding surface 26 extends at least approximately semicircular around the rotational axis 22 of the saw blade 8. Link blocks 27, which are provided at a support arm 28, are guided in the guide link 25 of the guiding surface 26 that is provided at the drive arm 24. The link blocks 27 are established in the embodiment by two supporting tappets 29, which are distanced to each other in the direction of the extension of the guiding surface 26. The support arm 28 extends from the drive arm 24 against the saw blade 8 and ends against the saw blade 8 in yoke arms 30, in between which a guiding roller 32 lies as supporting element 31 in the configuration according to FIG. 2 and a cylinder-shaped guiding body 33 as supporting element 31 in the configuration according to FIG. 3. The guiding roller 32 provides a guiding channel at its circumferences, into which the saw blade 8 encroaches with its saw blade back 9 and which overlaps the flanks of the saw blade 8 in the back area. The cylinder-shaped guiding body 33 that is arranged in a rotatable manner or fixed in position, provides a concavely vaulted supporting area 34 at the circumferences, as it is in particular illustrated in the schema illustration according to FIG. 5. The saw blade 8 abuts against supporting area 34 on the back side, namely only with its saw blade back 9. That is, as FIG. 5 shows, preferably construed rounded, so that only a linear contact results towards the guiding surface 34. A contour course proves to be useful for the guiding surface 34 in coordination with the corresponding supported saw blade 8, which corresponds approximately with a circular arc around the rotational axis 22 of the saw blade 8 with a radius, which—see FIG. 5—at least approximately corresponds in its angular point with the distance of the rotational axis 22 to the saw blade back 9.

FIG. 4 shows in addition to FIGS. 2 and 3 a configuration of the support 20, at which the support arm is not only guided and supported to the drive arm 24 over the guiding surface 26, but additionally over a bow 35, which is guided over a case 38 in a rotatable manner basically coaxially to the rotational axis 22 beginning at the support arm 28, whereby the case 38 is for example stored on the lifting rod 36 or in a corresponding way in a not shown mounting, which contains the guiding for the lifting rod 36 and which can be pivoted in the pendulum stroke operation with the lifting rod 36. Due to this configuration of the support 20 it is stabilized in its position to the saw blade 8, in particular also against tilting forces, as they occur in particular in the pendulum stroke operation, but also at the rotation of the saw blade 8 over the support arrangement 37, if the adjustment of the saw blade 8 to the correspondingly desired rotational position takes place by it according to the invention. It is required for the pendulum stroke operation, just like for a combination of the pendulum stroke with the scrolling mode, different from the shown configuration in FIG. 4, to incorporate the support 20 with the rigid angle that is established over the bow 35 between the case 38 and the support arm 28 or the case 38 and the drive arm 24, for example over not shown, corresponding connections that allow angle adjustments, thus for example joint connections and/or or pivot connections.

The adjustment of the saw blade 8 according to the invention over a support arrangement 37 towards the rotational direction requires an only schematically indicated actuator 39, over which the support arm 28 is adjusted in scrolling mode into the correspondingly predefined rotational position with the illustrated supporting element 31 by a corresponding use of the saw blade 8 around its rotational axis 22, whereby the required guiding of the support arm 28 is ensured by the guiding surface 26 and the possibly provided rotational support over the bow 35. If, as illustrated, the support arm 28 impinges over the actuator 39 in scrolling mode, the drive arm is held fixed in position, for example on the opposite of the machine housing, which is not further shown.

It is also within the scope of the invention to realize the rotational position adjustment of the saw blade 8 with the shown basic arrangement, if the actuator 39 does not encroach upon the support arm 28 for the rotational angle adjustment for the saw blade 8, but, what is not shown, upon the drive arm 24, which then, different from the existing rules, has to be guided in a rotatable manner for the rotational drive itself additionally corresponding to the support arm 28 in a plane that is vertical to the rotational axis 22, in order to carry out the correspondingly desired supporting direction with regard to the corresponding rotational angle adjustment for the saw blade 8 in connection with corresponding angle position changes between the support arm 28 and the drive arm 24. But for the other operating modes on the other hand a locked arrangement of the drive arm 24 is required or only one that allows stroke movement in the direction of the arrow 23.

The illustrated usage of supporting tappets 29 as parts that are encroaching in the guiding surface 26 of the guiding link 25 is only exemplary; instead of such supporting tappets 29 also other form elements can be used, thus characteristics at the support arm 28 that are adjusted in the radius or spring bolts, which additionally allow a certain elasticity in the support of the saw blade 8 on the back.

1. Power tool, especially hand-held power tool, which is a jigsaw provided with a saw blade, which provides a rotational axis that is running in its longitudinal direction and which is driven in the direction of its rotational axis in a manner allowing stroke movement, and at which a support arrangement is provided for the saw blade on the back side that is rotating along with the saw blade wherein the saw blade has to be driven over the support arrangement in the direction of the rotation.

2. The power tool, especially hand-held power tool, which is a jigsaw provided with a saw blade, which provides a rotational axis that is running in its longitudinal direction and which is driven in the direction of its rotational axis in a manner allowing stroke movement, and at which a support arrangement is provided for the saw blade on the back side that is rotating along with the saw blade, in particular according to claim 1, wherein the support arrangement and the saw blade are arranged relatively rotatable to each other.

3. The power tool according to claim 1, wherein the support arrangement and the saw blade provide a position of their rotational axes that are at least approximately the same.

4. Power The power tool according to claim 1, wherein the saw blade is decoupled in its stroke movement towards the rotational movement.

5. The power tool according to claim 4 wherein the saw blade is driven in stroke direction over the lifting rod and rotationally guided towards the lifting rod over a case.

6. The power tool according to claim 4 wherein the saw blade is incorporated over the corresponding saw blade holder in a rotatable manner around its rotational axis.

7. The power tool according to claim 1, wherein the support arrangement can be adjusted along a guide surface that at least partially encompassing towards the saw blade, which lies at least almost concentrically towards the rotational axis of the saw blade.

8. The power tool according to claim 7 wherein the guide surface is construed as guiding link.

9. The power tool according to claim 1, wherein the support arrangement provides a support arm, which shows a supporting element that is supported against the saw blade back.

10. The power tool according to claim 9 wherein the supporting element provides a concavely vaulted supporting area, whose radius corresponds at least in the central area at least approximately with the distance of the rotational axis of the saw blade to the saw blade back.

11. The power tool according to claim 10 wherein the supporting area is construed with a curve that is stronger towards its rims.

12. The power tool according to claim 9, wherein the supporting element is construed by a supporting roller, which in particular provides a guiding channel that is encompassing the saw blade on the back at the circumferential side.

13. The power tool according to claim 9, wherein the support arm is construed as support yoke, which is supported in the area of its bridge in the guiding link and which is guided over link blocks that are arranged distanced along the guiding link, in particular in the form of tappets or rollers.

14. The power tool according to claim 1, wherein the guiding link is provided at a drive arm, which is driven in the pendulum stroke mode in sawing direction in a manner allowing stroke movement.

15. The power tool according to claim 9, wherein the support arm can be rotated over a supporting bridge, in particular a bow as a member of the supporting bridge around an axis that is at least approximately parallel towards the rotational axis of the saw blade.

16. The power tool according to claim 1, wherein the support arrangement can be adjusted in its rotational position by an actuator that attacks at the drive arm or at the support arrangement, in particular its support arm.

17. The power tool according to claim 1, wherein the saw blade provides a rounded saw blade back.
